(19) United States
(12) Patent Application Publication
(10) Pub. No.: US 2025/0275883 A1
(43) Pub. Date: Sep. 4, 2025

(54) NECK MASSAGER

(71) Applicant: GUANGDONG MOFA E-COMMERCE CO., LTD, Guangdong (CN)

(72) Inventors: Yongbiao XU, Guangdong (CN); Zhongming YANG, Guangdong (CN)

(21) Appl. No.: 18/277,454

(22) PCT Filed: Jun. 30, 2023
(86) PCT No.: PCT/CN2023/105142

§ 371 Date: Aug. 16, 2023

(30) Foreign Application Priority Data
Nov. 25, 2022 (CN) 202223154701.X
Nov. 25, 2022 (CN) 202223162909.6
Nov. 25, 2022 (CN) 202223162960.7

(51) Int. Cl. A61H 15/00

(52) U.S. Cl. CPC A61H 15/0078; A61H 2201/01; A61H 2201/1611

(57) ABSTRACT

The disclosure provides a neck massager including a main body, two clamping arms connected to two ends of the main body, respectively, and two clamping parts corresponding to the two clamping arms, respectively. The two clamping parts are rotatably disposed on the two clamping arms, respectively; the two clamping parts are disposed opposite to each other to clamp a user's neck; each clamping arm includes a first rotating axis, and each clamping part is rotatable around the first rotating axis; each clamping part includes at least a first end and a second end that are different in distance from the first rotating axis; each clamping part includes a circumferential side surrounding the first rotating axis; and the first end and the second end are respectively disposed at two ends of the circumferential side of each clamping part.

### CROSS REFERENCE TO RELATED APPLICATIONS

This application is a National Stage Appl. of International Patent Application No. PCT/CN2023/105142 with an international filing date of Jun. 30, 2023 and claims priorities of the following Chinese Patent Applications: 202223162960.7 filed on Nov. 25, 2022, 202223154701.X filed on Nov. 25, 2022, and 202223162909.6 filed on Nov. 25, 2022, the contents each of which are incorporated herein by reference thereto.

### TECHNICAL FIELD

The disclosure relates to the field of massage equipment, and more particularly, to a neck massager.

### BACKGROUND

With the increase of pace of life and the decrease of daily rest time, more and more people are developing bad habits during work and life, increasing the probability of developing neck symptoms. To alleviate neck fatigue and reduce the risk of neck disease, neck massage products have emerged, among which, neck massagers can soothe and relax the neck muscle tissue and eliminate neck fatigue through massaging the neck.

In the related art, a neck massager generally includes a middle main body and clamping arms connecting both ends of the main body. In use, the main body and the clamping arms are placed around the user's neck, the clamping arms at both ends clamp both sides of the user's neck, and the main body massages the user's neck.

However, due to differences in the neck of different people, the neck massager may not adapt to the neck of different people during the wearing process, which may make the users discomfortable.

### SUMMARY

To solve the aforesaid problems, one objective of the disclosure is to provide a neck massager that is adapted to the neck of different people.

To achieve the above objective, the disclosure provides a neck massager, comprising:
a main body;
two clamping arms, the two clamping arms being connected to two ends of the main body, respectively; and
two clamping parts corresponding to the two clamping arms, respectively;
two clamping parts are rotatably disposed on the two clamping arms, respectively; the two clamping parts are disposed opposite to each other to clamp a user's neck; each clamping arm comprises a first rotating axis, and each clamping part is rotatable around the first rotating axis; each clamping part comprises at least a first end and a second end that are different in distance from the first rotating axis; each clamping part comprises a circumferential side surrounding the first rotating axis; and the first end and the second end are respectively disposed at two ends of the circumferential side of each clamping part.

With respect to the neck massager of the disclosure, the first end and the second end are disposed on two opposite sides of the clamping part; and/or an outer circumference of the clamping part is covered with a first flexible sheath, and an outer circumference of the main body is covered with a second flexible sheath.

With respect to the neck massager of the disclosure, the clamping arm comprises a connecting arm and a first rotating shaft; the connecting arm is connected to one end of the main body; the first rotating shaft is disposed on an inner side of one connecting arm facing the other clamping arm, and the clamping part is rotatably disposed at one end of the first rotating shaft away from the connecting arm and is spaced with the connecting arm.

With respect to the neck massager of the disclosure, the neck massager further comprises a first rotating assembly; the first rotating assembly comprises a first rotating member and a first connecting member; the first rotating shaft comprises a rotating groove; and a first rotating hole provided on bottom of the rotating groove is coupling to external; the first rotating member is rotatably disposed in the rotating groove, and the first connecting member is disposed on the clamping part; and the first connecting member passes through the first rotating hole and is connected to the first rotating member.

With respect to the neck massager of the disclosure, the first connecting member comprises at least three first joint columns; the three first joint columns abut against a side wall of the first rotating hole, and a central line of the three first joint columns forms an acute triangle or a right triangle.

With respect to the neck massager of the disclosure, the neck massager further comprises a first positioning assembly; the first positioning assembly comprises a first positioning marble and a first positioning groove formed at one end of the first rotating shaft; the first positioning groove is disposed around the first rotating axis, and the first positioning marble is matched with the first positioning groove and/or the neck massager further comprises a first limiting assembly; the first limiting assembly comprises a first limit block and a limit groove formed in the clamping part; the first limit block is disposed on one end of the first rotating shaft, the limit groove is disposed around the first rotating axis, and the first limit block is disposed in the limit groove.

With respect to the neck massager of the disclosure, the two clamping arms are rotatably disposed on the two ends of the main body, respectively.

With respect to the neck massager of the disclosure, the main body comprises an inner side facing a wearing area of the neck massager and an outer side away from the wearing area; the end of the main body comprises a second rotating axis extending from the inner side to the outer side of the main body, and the clamping arm rotates relative to the main body around the second rotating axis.

With respect to the neck massager of the disclosure, the neck massager further comprises a second rotating assembly; the second rotating assembly comprises a second rotating member and a second connecting member; each clamping arm comprises a second rotating hole; one side of the second rotating hole is provided with a limit part disposed inside the clamping arm; the limit part comprises a block part; the second rotating member is disposed on one side of the block part away from the second rotating hole; the second connecting member is disposed on the main body, and the second connecting member passes through the second rotating hole and is connected to the second rotating member.

With respect to the neck massager of the disclosure, the second rotating member comprises a first circular arc wall, and the limit part comprises a second circular arc wall facing the second rotating hole; the first circular arc wall is matched with the second circular arc wall, and the block part is disposed on the second circular arc wall; and/or the limit part is disposed on one side of the second rotating hole away from the clamping part.

With respect to the neck massager of the disclosure, the neck massager further comprises a second positioning assembly; the second positioning assembly comprises a second positioning marble and a second positioning groove formed in the block part; the second positioning groove is disposed on one side of the block part facing the second rotating hole; the second positioning marble is disposed on the main body, the second positioning groove is disposed around the second rotating axis, and the second positioning marble is matched with the second positioning groove.

With respect to the neck massager of the disclosure, the second connecting member comprises at least two second joint columns; one end of the main body comprises a positioning column; the second positioning marble is retractably disposed in the positioning column; the two second joint columns and the positioning column are respectively connected to a side wall of the second rotating hole, and a central line between the two second joint columns and the positioning column forms an acute triangle or a right triangle.

With respect to the neck massager of the disclosure, the neck massager further comprises a second limiting assembly; the second limiting assembly comprises a second limit block and a stop block; the second limit block is disposed on the main body; and the stop block is disposed on the clamping arm, and is located on a rotation path of the second limit block around the second rotating axis.

With respect to the neck massager of the disclosure, the second limit block is the second connecting member, and the stop block is the block part.

With respect to the neck massager of the disclosure, each of the two clamping arms is swingable at one end of the main body towards or away from the other clamping arm.

With respect to the neck massager of the disclosure, the neck massager further comprises a swingable connection assembly; the two ends of the main body are respectively connected to the two clamping arms through the swingable connection assembly, so that the two clamping arms are swingable towards or departing from each other;
the swingable connection assembly comprises a first connecting part, a second connecting part, and a swinging member; the first connecting part comprises a first installation position; the second connecting part comprises an inner side facing the first connecting part and an outer side away from the first connecting part; the second connecting part comprises a mounting hole connecting the inner side and the outer side, and the mounting hole is opposite to the first installation position; the outer side of the second connecting part comprises a third rotating member, and the third rotating member is located on one side of the mounting hole; the swinging member comprises a fourth rotating member and a second installation position, and is disposed through the mounting hole; the fourth rotating member is rotatably connected to the third rotating member, and the second installation position is connected to the first installation position; and
the first connecting part is disposed on the main body, and the second connecting part is disposed on each of the two clamping arms.

With respect to the neck massager of the disclosure, the third rotating member is two in number, and two third rotating members are respectively disposed on two sides of the mounting hole; the fourth rotating member is two in number, and the second installation position is located between the two fourth rotating members, and the two fourth rotating members are rotationally connected to the two third rotating members, respectively.

With respect to the neck massager of the disclosure, the neck massager further comprises a second rotating shaft; the third rotating member comprises a third rotating hole, the fourth rotating member comprises a fourth rotating hole, and the second rotating shaft passes through the third rotating hole and the fourth rotating hole on both sides.

With respect to the neck massager of the disclosure, the second rotating shaft comprises a middle section and a telescopic section located at both ends of the middle section; a diameter of the telescopic section and the third rotating hole is smaller than a diameter of the middle section; the middle section is disposed through the fourth rotating hole, and the telescopic section is disposed through the third rotating hole.

With respect to the neck massager of the disclosure, the neck massager further comprises a torsional spring; the torsional spring is disposed on the second rotating shaft; the swinging member comprises a blind hole, a first end of the torsional spring is disposed through the blind hole, and a second end of the torsional spring is pressed on an outer side of the second connecting part.

With respect to the neck massager of the disclosure, the torsional spring and the blind hole are both two in number; first ends of two torsional springs are respectively disposed through two blind holes, and second ends of the two torsional springs are connected and pressed on the outer side of the second connecting part.

With respect to the neck massager of the disclosure, the neck massager further comprises a screw fastener; the first installation position is a threaded hole, the second installation position is a through hole, and the screw fastener is threaded through the through hole and connected to the threaded hole; or the first connecting part comprises a connecting groove, and the swinging member is installed in the connecting groove; the first installation position is located at a bottom of the connecting groove, and one side of the bottom of the connecting groove comprises a first wiring hole connected to the first connecting part; a second wiring hole is formed between the swinging member and a side wall of the mounting hole, and the first wiring hole communicates with the second wiring hole; or the neck massager further comprises a third connecting member; the first connecting part comprises a supporting shell and a connecting shell; the supporting shell is detachably connected to the connecting shell; the connecting shell comprises a first mounting hole, the supporting shell comprises a second mounting hole, and the first mounting hole is connected to the second mounting hole through the third connecting member.

In the disclosure, the neck massager is placed on the neck of the user and clamps the user by two clamping parts to realize the wearing of the neck massager, and since the clamping part is rotatable with respect to the clamping arm, it is possible to rotate the clamping part according to the needs of the user to adapt the clamping part to the user's neck, so as to be applicable to different people, thus improving the user's experience of the product.

### BRIEF DESCRIPTION OF THE DRAWINGS

To illustrate the technical solutions in the embodiments or prior art of the disclosure, the following will briefly introduce the accompanying drawings used in the description of the embodiments or prior art, it should be noted that the following description of the accompanying drawings is only some of the embodiments of the disclosure, for those skilled in the art, without creative labor, there are also other structures based on the present drawings to get other the accompanying drawings.

FIG. 1 is a schematic diagram of a neck massager of one embodiment of the disclosure;

FIG. 2 is a first exploded view of a neck massager of one embodiment of the disclosure;

FIG. 3 is a second exploded view of a neck massager of one embodiment of the disclosure;

FIG. 4 is a third exploded view of a neck massager of one embodiment of the disclosure;

FIG. 5 is a first sectional view of a neck massager of one embodiment of the disclosure;

FIG. 6 is a schematic diagram of a clamping part of a neck massager of one embodiment of the disclosure;

FIG. 7 is a fourth exploded view of a neck massager of one embodiment of the disclosure;

FIG. 8 is a fifth exploded view of a neck massager of one embodiment of the disclosure;

FIG. 9 is a sixth exploded view of a neck massager of one embodiment of the disclosure;

FIG. 10 is a second sectional view of a neck massager of one embodiment of the disclosure;

FIG. 11 is a schematic diagram of a swingable connection assembly of a neck massager of one embodiment of the disclosure;

FIG. 12 is a first exploded view of a swingable connection assembly of a neck massager of one embodiment of the disclosure; and

FIG. 13 is a second exploded view of a swingable connection assembly of a neck massager of one embodiment of the disclosure.

Legends: 100: Main body; 100a: limiting zone; 101: Second flexible sheath; 102: Massage module; 103: supporting shell; 104: connecting shell; 200: clamping arm; 201: outer arm; 202: inner arm; 300: clamping part; 300a: first groove; 301: first flexible sheath; 302: support shell; 303: outer shell; 310: first end; 320: second end; 11: first rotating shaft; 11a: rotating groove; 11b: first rotating hole; 12: First rotating member; 13: First connecting member; 21: First positioning marble; 22: First positioning groove; 23: First guide groove; 31: First limit block; 32: Limit groove; 41: Limit part; 411: Block part; 41a: Second rotating hole; 42: Second rotating member; 43: Second connecting member; 51: Second positioning marble; 52: Second positioning groove; 53: Second guide groove; 60: First connecting part; 103a: Connection groove; 60a: Connecting groove; 60b: first installation position; 60c: First wiring hole; 70: Second connecting part; 70a: Mounting hole; 70b: Second wiring hole; 71: Third rotating member; 72: convex block; 80: Swinging member; 80a: Second installation position; 81: Fourth rotating member; 91: Second rotating shaft; 92: Torsional spring.

### DETAILED DESCRIPTION

The technical solutions in the embodiments of the disclosure will be described clearly and completely in the following in conjunction with the accompanying drawings in the embodiments of the disclosure, and it is obvious that the described embodiments are only a part of the embodiments of the disclosure, and not all of the embodiments. Based on the embodiments in this application, all other embodiments obtained by a person of ordinary skill in the art without making creative labor fall within the scope of protection of this application.

It should be noted that all directional indications (such as up, down, left, right, forward, back . . . ) in the embodiments of the disclosure are used only for explaining the relative positional relationship, movement, etc., among the components in a particular attitude, and that the directional indications change accordingly when that particular attitude is changed.

It should also be noted that when an element is described to be “fixed to” or “disposed on” another element, it may be directly on the other element or there may be an intermediate element at the same time. When an element is mentioned to be “connected” to another element, it may be directly connected to the other element or it may be indirectly connected to the other element through the intermediate element.

Furthermore, the descriptions of “first”, “second”, etc. in this application are used for descriptive purposes only, and are not to be construed as indicating or implying their relative importance or implicitly specifying the number of technical features indicated. As a result, an element defined as “first” or “second” may include at least one such element, either explicitly or implicitly. In addition, the technical solutions of the various embodiments may be combined with each other, but it must be based on the fact that a person of ordinary skill in the art is able to produce them, and when the combination of the technical solutions is contradictory or unattainable, it should be considered that the combination of such technical solutions does not exist, and is not included in the scope of protection claimed in the disclosure.

A neck massager can massage the neck of a user wearing the neck massager, and in the wearing state, the sides of the neck of the user are clamped by the clamping arms, and the main body is located at the back side of the neck of the user. However, in view of the differences in the necks of different people, it is difficult for conventional neck massagers to adapt to the necks of different people. In this regard, the disclosure provides a neck massager that can be adapted to the neck of a user by adjusting the angle of the clamping part relative to the clamping arms to meet the needs of different people.

It is understood that the neck massager given in the disclosure is mainly used for the massage of the neck, but of course, it can also be used for the massage of the shoulder or the leg, etc., according to the needs.

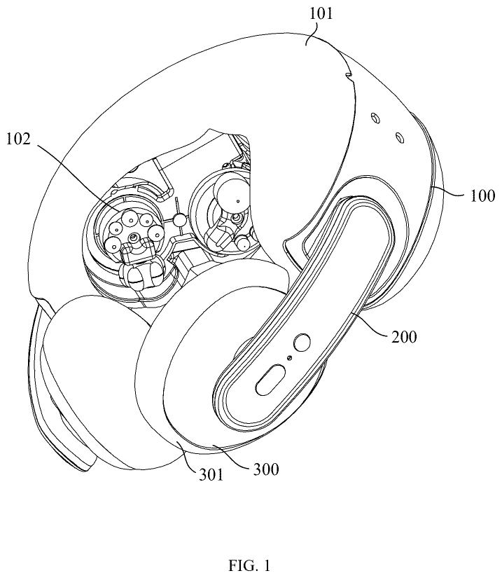

As shown in FIGS. 1-5, a neck massager of the disclosure comprises a main body 100, two clamping arms 200, and two clamping parts 300.

The two clamping arms 200 are connected to two ends of the main body 100, respectively; the two clamping parts 300 are corresponding to the two clamping arms 200, respectively; the two clamping parts 300 are rotatably disposed on the two clamping arms 200, respectively; the two clamping parts are disposed opposite to each other to clamp a user's neck; each clamping arm 200 comprises a first rotating axis, and each clamping part 300 is rotatable around the first rotating axis; each clamping part 300 comprises at least a first end 310 and a second end 320 that are different in distance from the first rotating axis; each clamping part 300 comprises a circumferential side surrounding the first rotating axis; and the first end 310 and the second end 320 are respectively disposed at two ends of the circumferential side of each clamping part 300.

Understandably, the main body 100, the two clamping arms 200, and the two clamping parts 300 are enclosed to form a wearing area, and the two clamping parts 300 clamp both sides of the neck. The main body 100 is a main massage element of the neck massager, and a massage module 102 is disposed on the inner side of the main body 100 toward the wearing area, and after the neck massager is worn, the main body 100 is tightly attached to the user's neck to massage the user's neck through the massage module 102.

In addition, the inner side of the clamping part 300 towards the wearing area functions to clamp the neck of the user, and the outer side of the clamping part 300 away from the wearing area is pivotally connected to the clamping arm 200. It is to be understood that the circumferential side of the clamping part 300 is located between the inner and outer sides of the clamping part 300, and the first end 310 and the second end 320 of the clamping part 300 may be located in a position opposite to the circumferential side of the clamping part 300 or in a position not opposite to the circumferential side of the clamping part 300, as long as the clamping part 300, in the process of rotating, can make the wearing size of the neck massager as a whole change or make the clamping position of the clamping part 300 change.

Thus, because the clamping part 300 comprises at least the first end 310 and the second end 320 with different distances from the rotating axis, so that, in the process of rotating the clamping part 300, the end of the clamping part 300 away from the clamping arm 200 can at least undergo a length change in the process of rotation with respect to the rotating axis, and the wearable size of the neck massager as a whole changes, and, the clamping position of the clamping part 300 can be changed accordingly to realize adaptive adjustment for different users.

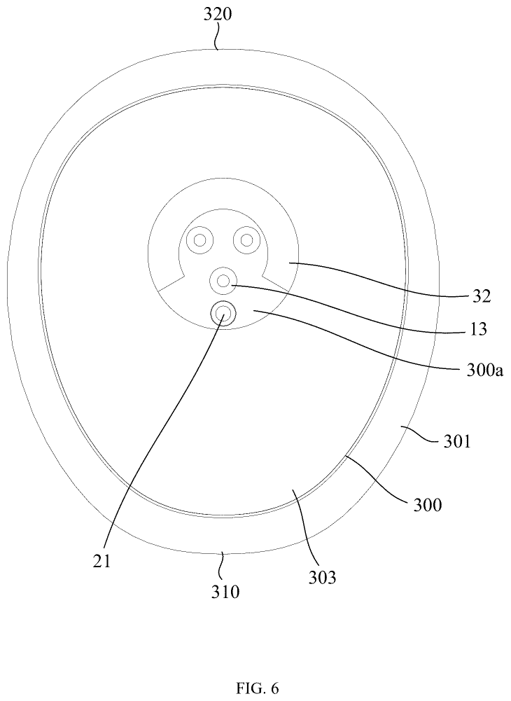

As shown in FIG. 6, in one embodiment of the disclosure, the first end 310 and the second end 320 of the clamping part 300 are located on opposite sides of the clamping part 300, respectively.

In this way, the clamping part 300 may be rotated until the first end 310 is away from the main body 100 or the second end 320 is away from the main body 100, thus realizing the adjustment of the overall wearing size of the neck massager to meet the needs of different users. Moreover, the clamping part 300 may also be rotated to be tilted to be adapted to the user's neck when needed.

In a specific embodiment of the disclosure, the clamping part 300 is in the shape of an ovoid, and the first end 310 and the second end 320 of the ovoid clamping part 300 are asymmetrical; the first end 310 is large, while the second end 320 is small, and the rotating axis is located at the symmetry axis of the clamping part 300 and passes through one side of the clamping part 300 near the second end 320. Such a shape can make the user more comfortable, and the different angles of the clamping part 300 relative to the clamping arm 200 can be adapted to different neck shapes, making the neck massager more versatile.

Optionally, in other embodiments, the clamping part 300 may also be a circular shape, with the rotating axis deviating from the center of the circle, to achieve corresponding adjustment. Alternatively, the clamping part 300 may be an elliptical shape, a spindle shape, etc., as long as it can be adapted to fit different necks at different adjustment angles.

In this embodiment, the neck massager is placed on the neck of the user and clamps the user by two clamping parts 300 to realize the wearing of the neck massager, and since the clamping part 300 is rotatable with respect to the clamping arm 200, it is possible to rotate the clamping part 300 according to the needs of the user to adapt the clamping part 300 to the user's neck, so as to be applicable to different people, thus improving the user's experience of the product.

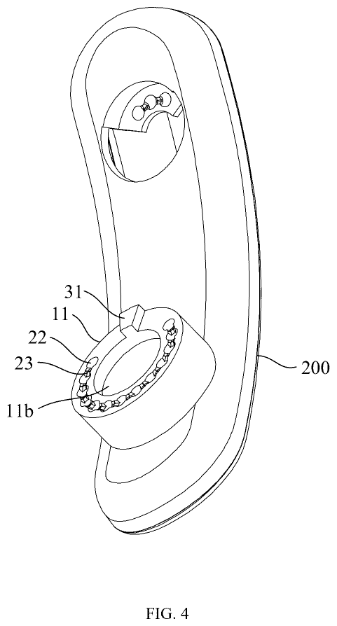

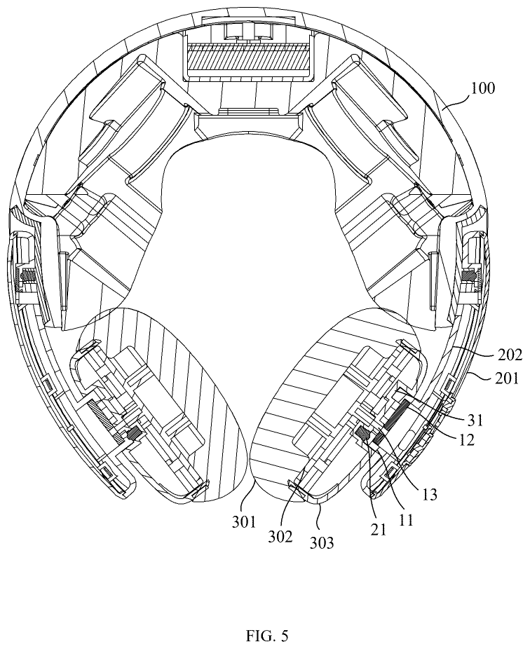

In an optional embodiment of the disclosure, as shown in FIGS. 4 and 5, the clamping arm 200 comprises a connecting arm and a first rotating shaft 11; the connecting arm is attached to one end of the main body 100; the first rotating shaft 11 is disposed on the inner side of the connecting arm toward the other clamping arm 200, and the clamping part 300 is rotatably disposed on the end of the first rotating shaft 11 away from the connecting arm and is spaced with the connecting arm.

Understandably, the inner side of the clamping arm 200 is the side facing the wearing area. In the presence of the first rotating shaft 11, the clamping part 300 will not be interfered by the connecting arm in the process of rotation, so as to facilitate the adjustment of the rotation of the clamping part 300. Moreover, it is to be known that during rotation of the clamping part 300 around the rotating axis, one end of the clamping part 300 away from the main body 100 will cross the end of the clamping arm 200 away from the main body 100, so as to ensure that during the wearing process, it is mainly the clamping part 300 that clamps the user's neck, thus ensuring the user wears the neck massager comfortably.

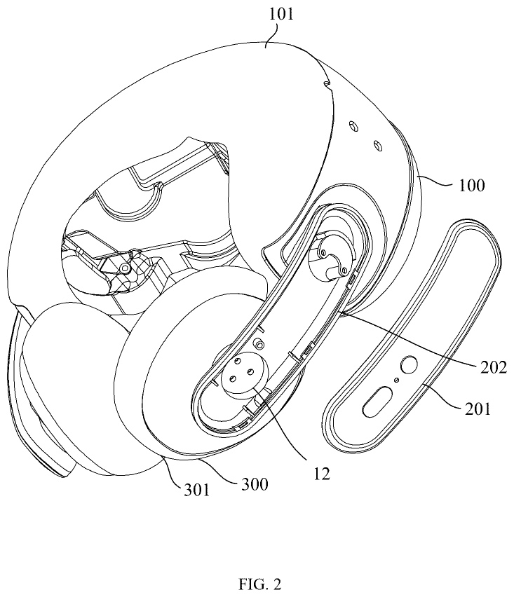

In another embodiment of disclosure, as shown in FIGS. 2, 3, and 5, the neck massager further a first rotating assembly; the first rotating assembly comprises a first rotating member 12 and a first connecting member 13; the first rotating shaft 11 comprises a rotating groove 11a; a first rotating hole 11b provided on bottom of the rotating groove 11a is coupling to external; the first rotating member 12 is rotatably disposed in the rotating groove 11a, and the first connecting member 13 is disposed on the clamping part 300; and the first connecting member 13 passes through the first rotating hole 11b and is connected to the first rotating member 12.

The rotation of the first rotating member 12 within the rotating groove 11a realizes the rotation of the clamping part 300 with respect to the first rotating shaft 11. Optionally, in order to avoid movement of the clamping part 300 towards or away from the clamping arm 200, the clamping part 300 comprises a first groove 300a, and the end portion of the first rotating shaft 11 is affixed to the bottom of the first groove. The first connecting member 13 is disposed in the bottom of the first groove 300a and is connected to the first rotating member 12, and the first rotating member 12 is affixed to the bottom of the rotating groove 11a. Because the end portion of the first rotating shaft 11 is located between the first rotating member 12 and the first groove 300a, relative movement therebetween is avoided. Optionally, the first rotating member 12 is a disk adapted to fit inside the cylindrical rotating groove 11a.

Optionally, in other embodiments, in the absence of the first rotating shaft 11, the first rotating hole 11b is disposed on the inner side of the clamping arm 200.

In an optional embodiment of the disclosure, the first connecting member 13 comprises at least one first joint column; the first rotating member 12 comprises at least one through-hole; the first joint column comprises a threaded hole, and a screw is threaded through the through-hole and threaded through the threaded hole of the first joint column to connect the first connecting member 13 and the first rotating member 12.

In an optional embodiment of the disclosure, the first connecting member 13 comprises at least three first joint columns; the three first joint columns abut against the side wall of the first rotating hole 11b, and a central line of the three first joint columns forms an acute triangle or a right triangle.

Understandably, the center axis of the first rotating hole 11b is the rotating axis. Thus, the clamping part 300 is able to rotate stably around the axis center without wobbling. Preferably, the centers of the three first joint columns form an equilateral triangle. It is understood that on this basis, more first joint columns may be provided to strengthen the connection between the clamping part 300 and the first rotating member 12.

Optionally, in other embodiments, the first connecting member 13 comprises only two first joint columns, and the center line of the two first joint columns passes through the center axis of the first rotating hole 11b. Alternatively, the first connecting member 13 comprises only one first joint column, and the clamping part 300 is provided with an annulated column matched with the first rotating hole 11b, so that the clamping part 300 is stabilized to rotate about the rotating axis. Under this condition, the position of the first joint column is arbitrary.

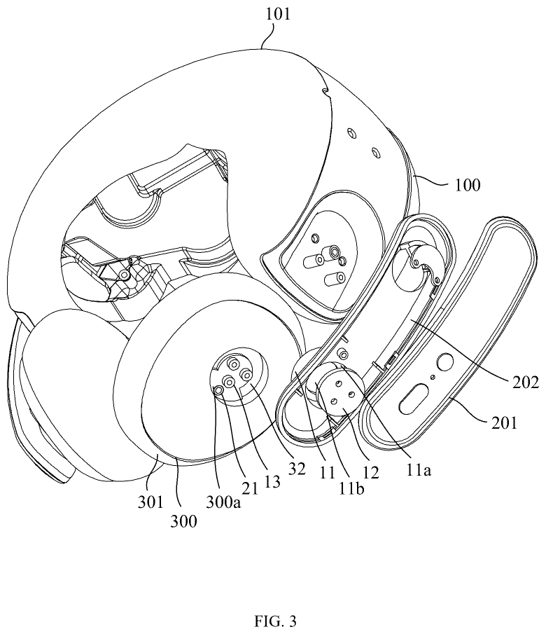

In a further embodiment of the disclosure, as shown in FIGS. 3-5, the neck massager further comprises a first positioning assembly; the first positioning assembly comprises a first positioning marble 21 and a first positioning groove 22 formed at one end of the first rotating shaft 11; the first positioning groove 22 is disposed around the first rotating axis, and the first positioning marble 21 is matched with the first positioning groove 22.

Through the arrangement of the first positioning assembly, the clamping part 300 can be limitedly rotated relative to the clamping arm 200 and be positioned at a desired position to ensure the stability of the clamping part 300 when rotating to the desired position. Specifically, the first positioning marble 21 is disposed in the first marble groove formed in the clamping part 300, and the first marble groove can restrict the first positioning marble 21 from detaching. In addition, an elastic member is disposed between the first positioning marble 21 and the bottom of the first marble groove, so that the first positioning marble 21 tends to protrude out of the first marble groove and is adapted to fit inside the first positioning groove 22. During rotation, when the first positioning marble 21 is not in the first positioning groove 22, it tends to move towards the first marble groove and enter one of the first positioning grooves 22, thus realizing the positional fixation of the clamping part 300. Optionally, the first marble groove is located at the bottom of the first groove 300a to match with the first positioning groove 22 at the end of the first rotating shaft 11.

In a preferred embodiment of the disclosure, the plurality of first positioning grooves 22 are connected by a first guide groove 23. The width of the first guide groove 23 is smaller than that of the first positioning grooves 22, and the width of the first guide groove 23 is increasingly large when approaching the first positioning grooves 22, so that during rotation of the clamping part 300, the first positioning marble 21, after being detached from one of the first positioning grooves 22, moves along the first guide groove 23, which can make the rotation of the clamping part 300 smoother.

Optionally, in other embodiments, in the case where the first rotating shaft 11 is not provided, the first positioning groove 22 is disposed on the inner side of the clamping arm 200 and around the first rotating hole 11b.

In addition, in other embodiments, in the absence of the first positioning assembly, the clamping part 300 can rotate infinitely relative to the clamping arm 200, and the stabilization of the clamping part 300 with respect to the clamping arm 200 can be achieved by the damping action of the first rotating assembly.

In another embodiment of the disclosure, optionally, as shown in FIGS. 3-5, the neck massager further comprises a first limiting assembly; the first limiting assembly comprises a first limit block 31 and a limit groove 32 formed in the clamping part 300; the first limit block 31 is disposed on one end of the first rotating shaft 11, the limit groove 32 is disposed around the first rotating axis, and the first limit block 31 is disposed in the limit groove 32.

The first limiting assembly is provided to limit the rotation angle of the clamping part 300, so as to avoid damage to the first limiting assembly caused by excessive rotation of the clamping part 300. Specifically, during the rotation of the clamping part 300, the first limit block 31 will also move in the limit groove 32, and the limiting of the first limit block is realized by the blocking at both ends of the limit groove 32. Optionally, the limit groove 32 is disposed at the bottom of the first groove 300a and is in a circular arc shape, and the first limit block 31 is disposed at the end of the first rotating shaft 11, embedded in the limit groove 32, and is adapted with the width of the limit groove 32, so as to make the first limit block 31 move relatively stably within the limit groove 32.

Optionally, in the absence of the first rotating shaft 11, the first limit block 31 is disposed on the inner side of the clamping arm 200.

In an optional embodiment of the disclosure, as shown in FIG. 1, the outer circumference of the clamping part 300 is covered with a first flexible sheath 301, and the outer circumference of the main body 100 is covered with a second flexible sheath 101.

Understandably, the first flexible sheath 301 covers at least the inner side of the clamping part 300 towards the wearing area, and the second flexible sheath 101 covers at least the inner side of the main body 100 towards the wearing area, so that the first flexible sheath 301 and the second flexible sheath 101 fit around the neck of the user in the wearing state, so as to make the user comfortable.

In an optional embodiment of the disclosure, as shown in FIG. 5, the clamping part 300 includes an outer shell 303, a support shell 302, and a first flexible sheath 301; the support shell 302 and the outer shell 303 are connected; the first flexible sheath 301 is wrapped around the support shell 302, and the aforementioned first groove 300a is disposed on the outer shell 303; the first joint column comprises a threaded groove that extends through the outer shell 303 and extends to the support shell 302; the first rotating member 12 comprises a through-hole, and when the first rotating member 12 is connected to the firs connecting member 13, a screw passes through the through-hole and is fixed in the threaded groove.

In a further optional embodiment of the disclosure, the support shell 302 comprises a clamping hole on the outer periphery; the outer shell 303 comprises a clamping hook facing the support shell 302; the clamping hook fits into the clamping hole, and the stabilized connection of the support shell 302 and the outer shell 303 is achieved by the aforementioned screw threaded through the through hole and the threaded groove.

In a further optional embodiment of the disclosure, the main body 100 includes a supporting shell 103, a connecting shell 104, a second flexible sheath 101, and a massage module 102. The massage module 102 is disposed on the supporting shell 103; the connecting shell 104 is disposed on both ends of the supporting shell 103; the second flexible sheath 101 covers the inner side of the supporting shell 103 toward the wearing area, and the clamping arm 200 is connected to the connecting shell 104.

In a further optional embodiment of the disclosure, as shown in FIG. 5, the clamping arm 200 includes an inner arm 202 and an outer arm 201 connected to the inner arm; the inner arm 202 is rotationally connected to the outer shell 303, and the first rotating shaft 11 is disposed in the inner arm 202.

In further optional embodiments of the disclosure, the first flexible sheath 301 is detachably connected to the clamping part 300, and the second flexible sheath 101 is detachably connected to the main body 100, thus facilitating the replacement and cleaning of the first flexible sheath 301 and the second flexible sheath 101.

In an optional embodiment of the disclosure, the clamping arm 200 is rotatably disposed at one end of the main body 100.

The disclosure provides a neck massager that can be adapted to fit a user's neck by adjusting the angle of the clamping arm relative to the main body to meet the needs of different people.

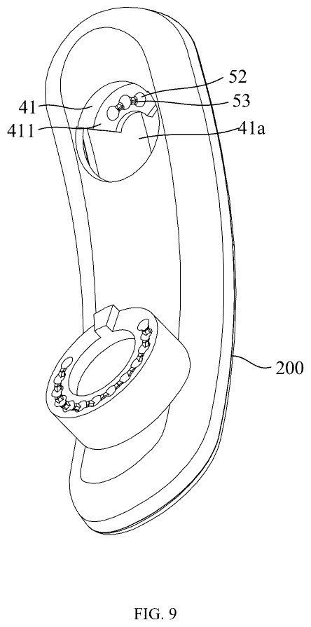

As shown in FIG. 1 and FIGS. 7 to 10, one embodiment of the disclosure provides a neck massager comprising: a main body 100, two clamping arms 200, and two clamping parts 300.

The main body 100 comprises an inner side facing the wearing area and an outer side away from the wearing area; two clamping arms 200 are attached to each end of the main body 100; the end of the main body 100 is provided with a rotating axis extending along the inner side to the outer side of the main body 100, and the clamping arms 200 rotate around the rotating axis relative to the main body 100; and the two clamping parts 300 are corresponding to the two clamping arms 200 one by one. The two clamping parts 300 are respectively disposed on the clamping arms 200.

It is understood that the main body 100 is the main massage element of the neck massager; the wearing area is an area formed by the main body 100, the two clamping arms 200, and the two clamping parts 300 for the user to wear. The two clamping parts 300 are used for clamping both sides of the neck, and the massage module 102 is disposed on the inner side of the main body 100 toward the wearing area. After the neck massager is worn, the main body 100 is tightly attached to the user's neck to massage the user's neck by the massage module 102.

In addition, the clamping arm 200 rotates around the rotating axis relative to the main body 100, and since the rotating axis extends along the inner side to the outer side of the clamping arm 200, after the neck massager is worn, the clamping arm 200 will rotate towards the upper side or the lower side of the main body 100 during its rotation relative to the main body 100, thereby adjusting the position and the angle of the clamping part 300 relative to the main body 100, and realizing the adaptive adjustment for different users.

In this embodiment, the neck massager is placed on the neck of the user and clamps the user by two clamping parts 300 to realize the wearing of the neck massager, and since the clamping arm 200 rotates relative to the main body 100 around the rotational axis, it is possible to rotate the clamping arm 200 according to the needs of the user to adjust the angle of the clamping arm 200 relative to the main body 100, and thus adjust the position and angle of the clamping part 300 relative to the main body 100 to adapt to the user's neck, so that it is applicable to different people, thus improving the user's experience.

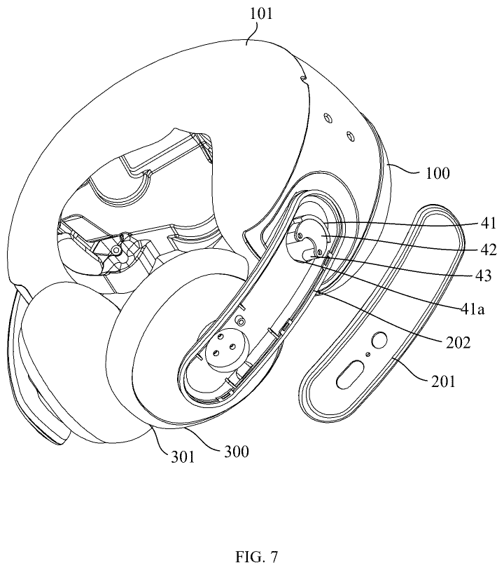

In an optional embodiment of the disclosure, as shown in FIGS. 7, 8 and 10, the neck massager further comprises a second rotating assembly; the second rotating assembly comprises a second rotating member 42 and a second connecting member 43; each clamping arm 200 comprises a second rotating hole 41a; one side of the second rotating hole 41a is provided with a limit part 41 disposed inside the clamping arm 200; the limit part 41 comprises a block part 411; the second rotating member 42 is disposed on one side of the block part 411 away from the second rotating hole 41a; the second connecting member 43 is disposed on the main body 100, and the second connecting member 43 passes through the second rotating hole 41a and is connected to the second rotating member 42.

Understandably, the limit part 41 functions to support the block part 411. The rotation of the second rotating member 42 with respect to the block part 411 drives the clamping arm 200 to rotate relative to the main body 100. And, due to the blocking of the block part 411, the second rotating member 42 is prevented from disengaging from within the clamping arm 200, ensuring a stable rotation.

In a further optional embodiment of the disclosure, the second rotating member 42 comprises a first circular arc wall, and the limit part 41 comprises a second circular arc wall facing the second rotating hole 41a; the first circular arc wall is matched with the second circular arc wall, and the block part 411 is disposed on the second circular arc wall.

Understandably, the rotating axis is through the center of the first circular arc wall and the second circular arc wall, and during the rotation of the second rotating member 42 relative to the block part 411, with appropriate first circular arc wall, the stable rotation of the second rotating member 42 and the stable rotation of the clamping arm 200 around the rotating axis are both ensured.

In an optional embodiment of the disclosure, the limit part 41 is located on the side of the second rotating hole 41a away from the clamping part 300.

In this embodiment, the limit part 41 is a circular arc block, and the second rotating hole 41a is not provided with a blocking structure or a support structure on other sides except for the limit part 41. Thus, to facilitate the threading of the wire from the other side edges of the second rotating hole 41a except for the limit part 41 into the clamping arm 200, and during the rotation of the clamping arm 200 relative to the main body 100, the connection of the wire is not affected, thus ensuring the use of the neck massager as a whole. Specifically, in an optional embodiment, an on/off button and/or an adjustment button is disposed on any of the clamping arms 200 and is connected to the massage assembly 102 within the main body 100 via the wires for ease of control by the user during use.

Optionally, in other embodiments, the limit part 41 is disposed around the second rotating hole 41a to ensure the stable rotation of the second rotating member 42 placed therein.

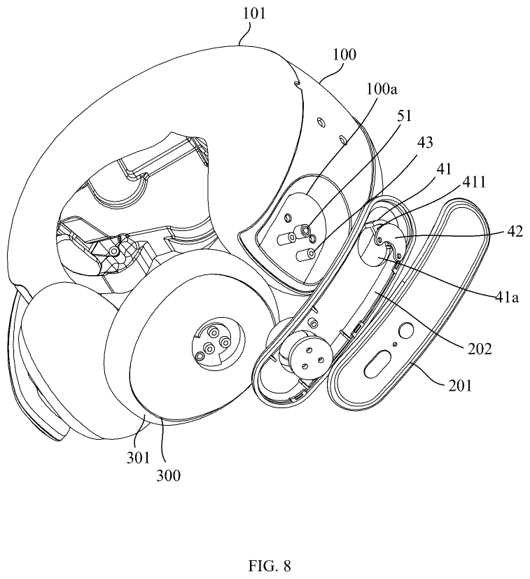

In another optional embodiment of the disclosure, as shown in FIGS. 8, 9, and 10, the neck massager further comprises a second positioning assembly; the second positioning assembly comprises a second positioning marble 51 and a second positioning groove 52 formed in the block part 411; the second positioning groove 52 is disposed on one side of the block part 411 facing the second rotating hole 41a; the second positioning marble 51 is disposed on the main body 100, the second positioning groove 52 is disposed around the second rotating axis, and the second positioning marble 51 is matched with the second positioning groove 52.

Through the arrangement of the second positioning assembly, the clamping arm 200 can be limitedly rotated relative to the main body 100 and be positioned at a desired position to ensure the stability of the neck massager when rotating to the desired position. Specifically, the second positioning marble 51 is disposed in the second marble groove formed in the main body 100, and the second marble groove can restrict the second positioning marble 51 from detaching. In addition, an elastic member is disposed between the second positioning marble 51 and the bottom of the second marble groove, so that the second positioning marble 51 tends to protrude out of the second marble groove and is adapted to fit inside the second positioning groove 52. During rotation, when the second positioning marble 51 is not in the second positioning groove 52, it tends to move towards the second marble groove and enter one of the second positioning grooves 52, thus realizing the positional fixation of the clamping part 300.

In a preferred embodiment of the disclosure, the plurality of second positioning grooves 52 are connected by a second guide groove 53. The width of the second guide groove 53 is smaller than that of the second positioning grooves 52, and the width of the second guide groove 53 is increasingly large when approaching the second positioning grooves 52, so that during rotation of the clamping part 300, the second positioning marble 51, after being detached from one of the second positioning grooves 52, moves along the second guide groove 53, which can make the rotation of the clamping part 300 smoother.

In addition, in other embodiments, in the absence of the second positioning assembly, the clamping part 300 can rotate infinitely relative to the clamping arm 200, and the stabilization of the clamping part 300 with respect to the clamping arm 200 can be achieved by the damping action of the second rotating assembly.

In an optional embodiment of the disclosure, the second connecting member 43 comprises at least one second joint column; the second rotating member 42 comprises at least one through-hole; the second joint column comprises a threaded hole, and a screw is threaded through the through-hole and threaded through the threaded hole of the second joint column to connect the second connecting member 43 and the second rotating member 42.

In an optional embodiment of the disclosure, as shown in FIG. 8, the second connecting member 43 comprises at least two second joint columns; one end of the main body 100 comprises a positioning column; the second positioning marble 51 is retractably disposed in the positioning column; the two second joint columns and the positioning column are respectively connected to the side wall of the second rotating hole 41a, and a central line between the two second joint columns and the positioning column forms an acute triangle or a right triangle.

Understandably, the second marble groove described above is formed at the end of the joint column, and the center axis of the second rotating hole 41a is the rotating axis. Thus, the clamping arm 200 is able to rotate stably around the axis center without wobbling. Understandably, on this basis, more second joint columns may be provided to strengthen the connection between the main body 100 and the second rotating member 42. Optionally, when three second joint columns are provided, the three second joint columns are respectively against the side walls of the second rotating hole 41a, and the center lines of the three second joint columns form an acute triangle or a right angle triangle.

Optionally, in other embodiments, the second connecting member 43 may also comprise only two second joint columns, and the center line of the two second joint columns passes through the center axis of the second rotating hole 41a. In this case, the position of the joint columns is not limited. Alternatively, the second connecting member 43 may comprise only one second joint column, and the main body 100 is provided with an annulated column matched with the second rotating hole 41a, so that the clamping arm 200 is stabilized to rotate about the rotating axis. Under this condition, the position of the second joint column is arbitrary.

In another optional embodiment of the disclosure, as shown in FIGS. 7-9, the neck massager further comprises a second limiting assembly; the second limiting assembly comprises a second limit block and a stop block; the second limit block is disposed on the main body 100; and the stop block is disposed on the clamping arm 200, and is located on the rotation path of the second limit block around the second rotating axis.

The second limiting assembly is provided to limit the rotation angle of the clamping arm 200, so as to avoid damage to the structure caused by the excessive amplitude of the clamping arm 200. Specifically, during the rotation process of the clamping arm 200, the restriction is realized by the blocking of the stop block.

In another optional embodiment of the disclosure, the second limit block is the second connecting member 43, and the stop block is the block part 411.

To connect the second rotating member 42 to the second connecting member 43, the end of the second rotating member 42 passes over the edge of the block part 411 and is connected to the second connecting member 43, where the edge of the block part 411 can be used to block the second connecting member 43. Specifically, the ends of the second rotating member 42 are respectively connected to the two second joint columns, optionally through screw fastening, to realize blocking restriction of the two second joint columns by means of the edge of the stop block.

Optionally, in other embodiments, the limit block is disposed on the inner side of the clamping arm 200, and a limit groove is provided in the main body 100, and the end of the limit groove is the stop block, to limit the rotation of the clamping arm 200.

As shown in FIG. 1 and FIGS. 7 to 10, the clamping arm 200 is rotationally attached to the outer side of the end of the main body 100, and the clamping part 300 is disposed on the inner side of the clamping arm 200 toward the wearing area.

The design aims to avoiding contact between the clamping arm 200 and the neck of the user, and to facilitate the rotational adjustment of the clamping arm 200 with respect to the main body 100.

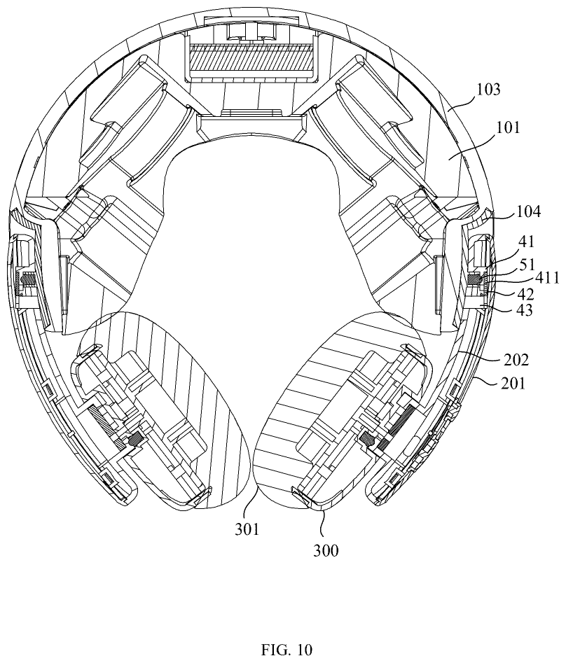

In another optional embodiment of the disclosure, as shown in FIG. 10, the main body 100 includes a supporting shell 103, a connecting shell 104, a second flexible sheath 101, and a massage module 102. The massage module 102 is disposed on the supporting shell 103; the connecting shell 104 is disposed on both ends of the supporting shell 103; the second flexible sheath 101 covers the inner side of the supporting shell 103 toward the wearing area, and the clamping arm 200 is connected to the connecting shell 104.

In another optional embodiment of the disclosure, as shown in FIG. 10, the clamping arm 200 includes an inner arm 202 and an outer arm 201 connected to the inner arm; the inner arm 202 is rotationally connected to the connecting shell 104; the inner arm 202 comprises a second rotating hole 41a; one side of the inner arm 202 facing the outer arm 201 comprises a limit part 41, and the second connecting member 43 is disposed on the outer side of the connecting shell 104 away from the wearing area.

In another optional embodiment of the disclosure, as shown in FIG. 8, the outer side of the connecting shell 104 is concavely provided with a limiting zone 100a; the clamping arm 200 is rotationally connected to the connecting shell 104, and the end portion of the clamping arm 200 is located in the limiting zone 100a, which on the one hand can make the entire outer side of the neck massager smooth, and on the other hand, can also limit the rotation of the clamping arm 200, which is convenient for the user to make rotational adjustments.

In another optional embodiment of the disclosure, the clamping arm 200 is swingably disposed at one end of the main body 100 and swingable towards or away from another clamping arm 200.

In this way, the clamping arm 200 can clamp and adapt to the user's neck to improve the user's experience.

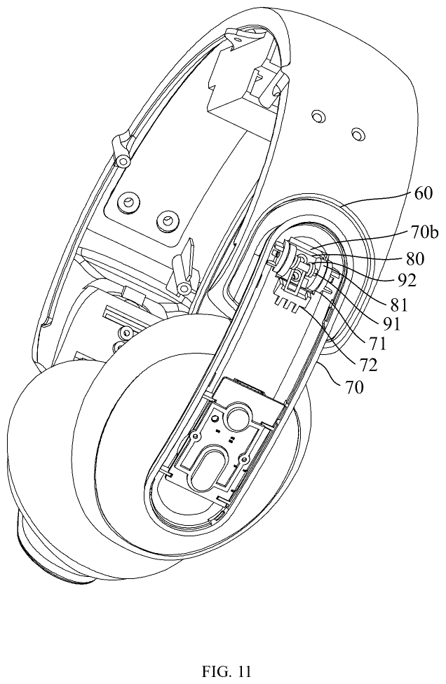

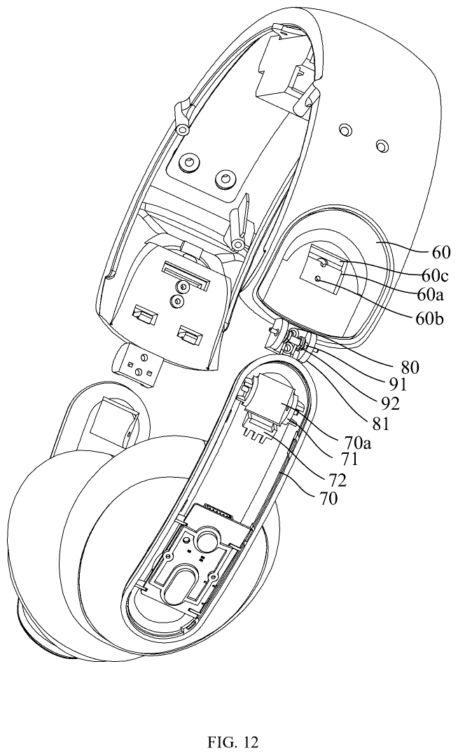

As shown in FIGS. 11-13, the neck massager of the disclosure further comprises a swingable connection assembly; the two ends of the main body 100 are respectively connected to the two clamping arms 200 through the swingable connection assembly, so that the two clamping arms 200 are swingable towards or departing from each other; the swingable connection assembly comprises a first connecting part 60, a second connecting part 70, and a swinging member 80; understandably, the first connecting part 60 and the second connecting part 70 are swingingly connected to each other through the swinging member 80 to realize the swinging of the second connecting part 70 relative to the first connecting part 60, and the swinging member, when applied to the neck massager, can realize the swinging of the clamping arm 200 relative to the main body 100.

The first connecting part 60 comprises a first installation position 60b; the second connecting part 70 comprises an inner side facing the first connecting part 60 and an outer side away from the first connecting part 60; the second connecting part 70 comprises a mounting hole 70a connecting the inner side and the outer side, and the mounting hole 70a is opposite to the first installation position 60b; the outer side of the second connecting part 70 comprises a third rotating member 71a, and the third rotating member 71 is located on one side of the mounting hole 70a; the swinging member 80 comprises a fourth rotating member 81 and a second installation position 80a, and is disposed through the mounting hole 70a; the fourth rotating member 81 is rotatably connected to the third rotating member 71, and the second installation position 80a is connected to the first installation position 60b. The first connecting part 60 is disposed on the main body 100, and the second connecting part 70 is disposed on each of the two clamping arms 200.

The connection between the second installation position 80a and the first installation position 60b realizes the connection between the swinging member 80 and the first connecting part 60, and through the rotational connection between the fourth rotating member 81 and the third rotating member 71, the rotation of the second mounting portion with respect to the swinging member 80 is realized, which in turn realizes the swinging of the second mounting portion with respect to the first mounting portion.

In the process of assembling the swingable connection assembly, the swinging member 80 is placed in the mounting hole 70a, and the fourth rotating member 81 is rotationally connected to the third rotating member 71 to realize the assembly of the swinging member 80 and the second connecting part 70. Thereafter, the second installation position 80a is connected to the first installation position 60b, and the swinging member 80 is connected to the first connecting part 60, thus achieving the assembly of the swingable connection assembly. Alternatively, as needed, the assembly of the swinging member 80 and the first connection portion 60 is first realized by connecting the second installation position 80a and the first installation position 60b, and then the swinging member 80 is placed in the mounting hole 70a, and the fourth rotating member 81 is rotationally connected to the third rotating member 71, to realize the assembly of the swinging member 80 and the second connection portion 70.

It can be seen that in the process of assembling the swingable connection assembly, the second connecting part 70, the swinging member 80, and the first connecting part 60 can be sequentially combined, or the first connection portion 60, the swinging member 80, and the second connection portion 70 are sequentially combined. Compared to the existing swingable connection assembly, the swingable connection assembly of the disclosure is simple to assemble, thus realizing the rapid and high efficient assembly of the product.

In another optional embodiment of the disclosure, as shown in FIGS. 11-13 the third rotating member 71 is two in number, and two third rotating members are respectively disposed on two sides of the mounting hole 70a; the fourth rotating member 81 is two in number, and the second installation position 80a is located between the two fourth rotating members 81, and the two fourth rotating members 81 are rotationally connected to the two third rotating members 71, respectively.

Understandably, in the process of combining the swinging member 80 and the second connecting part 70, the fourth rotating member 81 on both sides of the swinging member 80 is rotationally connected to the two third rotating members 71, respectively, to realize the assembly. Such a rotation structure may enable the second connecting part 70 to rotate relative to the swinging member 80 in a more stable manner.

In a further optional embodiment of the disclosure, the fourth rotating member 81 is disposed on both sides of the swinging member 80 and projected away from the main body 100, and the second installation position 80a is disposed between the two fourth rotating members 81.

In another optional embodiment of the disclosure, as shown in FIGS. 11-13, the neck massager further comprises a second rotating shaft 91; the third rotating member 71 comprises a third rotating hole, the fourth rotating member 81 comprises a fourth rotating hole, and the second rotating shaft 91 passes through the third rotating hole and the fourth rotating hole on both sides.

In this way, the arrangement of the second rotating shaft 91 ensures a stable rotational connection between the third rotating member 71 and the fourth rotating member 81. It is to be understood that in the process of combing the swinging member 80 and the second connecting part 70, the second rotating shaft 91 is threaded through the third rotating hole and the fourth rotating hole on both sides to realize the rotary connection of the third rotating member 71 and the fourth rotating member 81.

In another optional embodiment of the disclosure, the second rotating shaft 19 comprises a middle section and a telescopic section located at both ends of the middle section; a diameter of the telescopic section and the third rotating hole is smaller than a diameter of the middle section; the middle section is disposed through the fourth rotating hole, and the telescopic section is disposed through the third rotating hole.

Understandably, the two ends of the middle section comprise telescopic holes, and the telescopic sections are retractably disposed within the telescopic holes. The telescopic sections are movable to be housed within the telescopic holes or to be movable to protrude out of the end of the middle section. By disposing an elastic member within the middle section, the two telescopic sections tend to protrude out of the middle section. Thereby, in the process of combining the swinging member 80 and the second connecting part 70, the second rotating shaft 91 is first threaded into the two fourth rotating holes, and then the telescopic segments at the ends of the second rotating shaft 91 are pressed. The swinging member 80 is placed in the mounting hole 70a, and the fourth rotating hole is aligned with the third rotating hole. Through the repositioning of the telescopic segments of the second rotating shaft 91, the fourth rotating hole is threaded through the third rotating hole, thus realizing the rotation connection of the third rotating member 71 and the fourth rotating member 81. In this way, the second rotating shaft 91 does not need to occupy other positions of the first connection part 60 during installation, which is convenient for assembly, and the connection of the assembled rotating structure is stable, so that it is difficult for the second rotating shaft 91 to disengage from the third rotating hole and the fourth rotating hole without the interference of an external force.

In another optional embodiment of the disclosure, the neck massager further comprises a torsional spring 92; the torsional spring 92 is disposed on the second rotating shaft 91; the swinging member 81 comprises a blind hole, a first end of the torsional spring 92 is disposed through the blind hole, and a second end of the torsional spring 92 is pressed on the outer side of the second connecting part 70.

In the presence of the torsional spring 92, the first connecting part 60 tends to swing towards the direction of pressing the second end of the torsional spring 92. When used in the neck massager of the disclosure, the swingable connection assembly can ensure the clamping arms 200 on both sides clamp the user's neck for easy fitting and wearing. It can be understood that before combining the swinging member 80 and the second connecting part 70, the first end of the torsional spring 92 can be threaded through the blind hole, and then the second rotating shaft 91 can be threaded through the fourth rotating hole, and the torsional spring 92 can be threaded simultaneously. When combining the swinging member 80 and the second connecting part 70, the second end of the torsional spring 92 can be pressed onto the outer side of the second connecting part 70.

In another optional embodiment of the disclosure, the torsional spring 92 and the blind hole are both two in number; the first ends of two torsional springs 92 are respectively disposed through two blind holes, and the second ends of the two torsional springs 92 are connected and pressed on the outer side of the second connecting part 70.

In another optional embodiment of the disclosure, the outer side of the second connecting part 70 comprises a convex block 72, and the second end of the torsional spring 92 is pressed onto the convex block 72.

In this way, the second end of the torsional spring 92 is actually pressed onto the convex block 72, which can avoid damage to the main body of the second connecting part 70. Specifically, the swingable connection assembly can avoid damage to the inner arm 202 of the clamping arm 200 caused by the torsional spring 92 when applied to the neck massager.

In another optional embodiment of the disclosure, one side of the fourth rotating member 81 towards the third rotating member 71 protrudes out of the rotating shaft, and the third rotating member 71 comprises a rotating hole. The rotating shaft extends into the rotating hole, to achieve a rotational connection between the third rotating member 71 and the fourth rotating member 81.

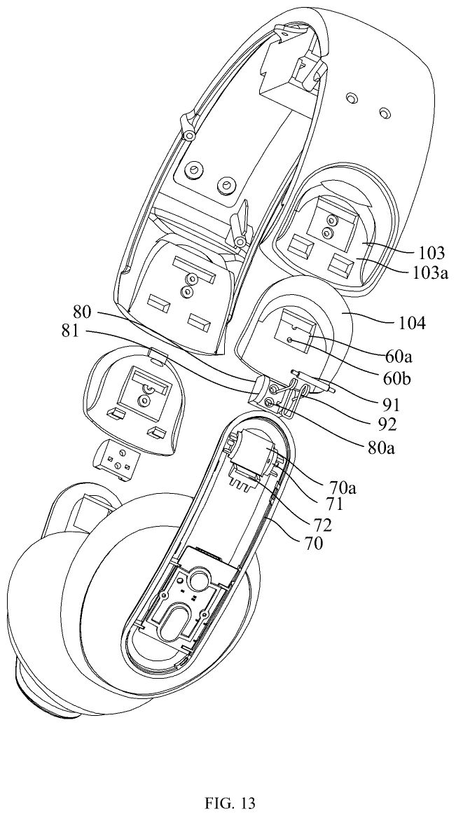

In another optional embodiment of the disclosure, as shown in FIG. 13, the neck massager further comprises a screw fastener; the first installation position 60b is a threaded hole, the second installation position 80a is a through hole, and the screw fastener is threaded through the through hole and connected to the threaded hole.

In this way, regardless of whether the swinging member 80 and the first connecting part 60 are installed first, or the swinging member 80 and the second connecting part 70 are installed first, and then the swinging member 80 and the first connecting part 60 are installed, only if the threaded holes and the through holes are aligned, and stable installation therebetween can be realized by means of the screws. Optionally, the number of the threaded holes and the through holes is plural to ensure stable installation. In this embodiment, the threaded holes and through holes are two in number, and are located between the two fourth rotating members 81. The two through holes are located on both sides of the second rotating shaft 91, so that even after the second rotating shaft 91 and the torsional spring 92 have been installed, they will not interfere with the connection of the second installation position 80a and the first installation position 60b.

Optionally, in other embodiments, to realize the connection between the swinging member 80 and the first connecting part 60, the first installation position 60b is a clamping hole and the second mounting bit 80a is a clamping hook, and the combination of the swinging member 80 and the first connecting part 60 can be quickly realized through the snap-fastener connection.

In one embodiment of the disclosure, the first connecting part 60 comprises a connecting groove 60a, and the swinging member 80 is installed in the connecting groove 60a; the first installation position 60b is located at the bottom of the connecting groove 60a, and one side of the bottom of the connecting groove 60a comprises a first wiring hole 60c connected to the first connecting part 60; a second wiring hole 70b is formed between the swinging member 80 and the side wall of the mounting hole 70a, and the first wiring hole 60c communicates with the second wiring hole 70b.

Understandably, the first wiring hole 60c and the second wiring hole 70b can be used for wires to pass through. For example, when the swingable connection assembly is applied to the neck massager, the first wiring hole 60c and the second wiring hole 70b may be available for wires to pass through between the key circuit board within the clamping arm 200 and the main board within the main body 100. Before combining the first connection part 60, the swinging member 80, and the second connection part 70, the wires can be passed through the first wiring hole 60c and the second wiring hole 70b to ensure that sufficient space is reserved for the wires in subsequent assemblies.

In one embodiment of the disclosure, the neck massager further comprises a third connecting member; the first connecting part 60 comprises a supporting shell 103 and a connecting shell 104; the supporting shell 103 is detachably connected to the connecting shell 104; the connecting shell 104 comprises a first mounting hole, the supporting shell 103 comprises a second mounting hole, and the first mounting hole is connected to the second mounting hole through the third connecting member.

Prior to combining the first connection part 60, the swinging member 80, and the second connection part 70, the supporting shell 103 and the connecting shell 104 may be combined.

Specifically, the supporting shell 103 comprises a connection groove 103a; a connection notch is provided on one side of the connection groove 103a, and a clamping hole is provided at the bottom of the connection groove 103a; the connecting shell 104 is disposed in the connection groove 103a, and one end of the connecting shell 104 extends into the connection notch and is clamped into the clamping hole by a clamping hook to realize the detachable connection between the connecting shell 104 and the supporting shell 103. And, the third connecting member reinforces the connection between the connecting shell 104 and the supporting shell 103. Further, the first mounting hole and the second mounting hole together form the aforementioned first installation position 60b. Exemplarily, the first mounting hole and the second mounting hole together form the aforementioned threaded hole, and the third connecting member is the aforementioned screw.

In this way, the screw enables a stable connection between the swinging member 80 and the first connecting part 60, and at the same time reinforce the connection between the connecting shell 104 and the supporting shell 103.

In one embodiment of the disclosure, as shown in FIG. 1, the clamping arm 200 is swingingly connected to the outer side of the end portion of the main body 100 by the swingable connection assembly, and the clamping part 300 is disposed on the inner side of the clamping arm 200 toward the wearing area.

In this way, the contact between the clamping arm 200 and the neck of the user is avoided, thus facilitating the swinging adjustment of the clamping arm 200 with respect to the main body 100.

In one embodiment of the disclosure, the clamping arm 200 includes an inner arm 202 and an outer arm 201 connected to the inner arm; the mounting hole 70a is formed on the inner arm 202; the third rotating member 71 is formed on the side of the inner arm 202 towards the outer arm 201, and the swinging member 80 is rotationally connected to the inner arm 202.

In one embodiment of the disclosure, the outer side of the connecting shell 104 is concavely provided with a limiting zone 100a; the clamping arm 200 is rotationally connected to the connecting shell 104, and the end portion of the clamping arm 200 is located in the limiting zone 100a, which on the one hand can make the entire outer side of the neck massager smooth, and on the other hand, can also avoid the rotation of the clamping arm 200, and maintain the structure's stability.

In other embodiments, the clamping arm 200 may also be fixed to the end of the main body 100, which is not detailed herein.

In one embodiment of the disclosure, as shown in FIG. 1, the main body 100 comprises a massage module 102 on the inner side toward the wearing area; the massage module 102 are two in number and symmetrically disposed on both sides of the main body 100, and the two massage modules 102 are disposed opposite to each other and tilted inside the main body 100 so as to face toward the user's neck to evenly massage the user's neck.

In one embodiment of the disclosure, the massage module 102 includes a movement and a massage head; the massage head is connected to the movement and extends out of the main body 100. The movement functions to drive the massage head to rotate and/or vibrate, so as to massage the neck of the user.

The above is only preferred embodiments of the disclosure and is not intended to limit the scope thereof. Any equivalent structural transformations made under the concept of the disclosure using the specification of the present application and the accompanying drawings, or directly/indirectly utilized in other related technical fields, are included in the scope of patent protection of the present application.

1. A neck massager, comprising:
a main body;
two clamping arms, the two clamping arms being connected to two ends of the main body, respectively; and
two clamping parts corresponding to the two clamping arms, respectively;
wherein:
the two clamping parts are rotatably disposed on the two clamping arms, respectively; the two clamping parts are disposed opposite to each other to clamp a user's neck; each clamping arm comprises a first rotating axis, and each clamping part is rotatable around the first rotating axis; each clamping part comprises at least a first end and a second end that are different in distance from the first rotating axis; each clamping part comprises a circumferential side surrounding the first rotating axis; and the first end and the second end are respectively disposed at two ends of the circumferential side of each clamping part.

2. The neck massager of claim 1, wherein the first end and the second end are disposed on two opposite sides of the clamping part; and/or an outer circumference of the clamping part is covered with a first flexible sheath, and an outer circumference of the main body is covered with a second flexible sheath.

3. The neck massager of claim 1, wherein each clamping arm comprises a connecting arm and a first rotating shaft; the connecting arm is connected to one end of the main body; the first rotating shaft is disposed on an inner side of the connecting arm facing the other clamping arm, and the clamping part is rotatably disposed at one end of the first rotating shaft away from the connecting arm and is spaced with the connecting arm.

4. The neck massager of claim 3, further comprising a first rotating assembly, wherein the first rotating assembly comprises a first rotating member and a first connecting member; the first rotating shaft comprises a rotating groove; and a first rotating hole provided on bottom of the rotating groove is coupling to external; the first rotating member is rotatably disposed in the rotating groove, and the first connecting member is disposed on the clamping part; and the first connecting member passes through the first rotating hole and is connected to the first rotating member.

5. The neck massager of claim 4, wherein the first connecting member comprises at least three first joint columns; the at least three first joint columns abut against a side wall of the first rotating hole, and a central line of the at least three first joint columns forms an acute triangle or a right triangle.

6. The neck massager of claim 3, further comprising a first positioning assembly, wherein the first positioning assembly comprises a first positioning marble and a first positioning groove formed at one end of the first rotating shaft; the first positioning groove is disposed around the first rotating axis, and the first positioning marble is matched with the first positioning groove and/or the neck massager further comprises a first limiting assembly; the first limiting assembly comprises a first limit block and a limit groove formed in the clamping part: the first limit block is disposed on one end of the first rotating shaft, the limit groove is disposed around the first rotating axis, and the first limit block is disposed in the limit groove.

7. (canceled)

8. (canceled)

9. The neck massager of claim 1, wherein the two clamping arms are rotatably disposed on the two ends of the main body, respectively.

10. The neck massager of claim 9, wherein the main body comprises an inner side facing a wearing area of the neck massager and an outer side away from the wearing area; the two ends of the main body comprises a second rotating axis extending from the inner side to the outer side of the main body, and each clamping arm rotates relative to the main body around the second rotating axis.

11. The neck massager of claim 10, further comprising a second rotating assembly, wherein the second rotating assembly comprises a second rotating member and a second connecting member; each clamping arm comprises a second rotating hole; one side of the second rotating hole is provided with a limit part disposed inside the clamping arm; the limit part comprises a block part; the second rotating member is disposed on one side of the block part away from the second rotating hole; the second connecting member is disposed on the main body, and the second connecting member passes through the second rotating hole and is connected to the second rotating member.

12. The neck massager of claim 11, wherein the second rotating member comprises a first circular arc wall, and the limit part comprises a second circular arc wall facing the second rotating hole; the first circular arc wall is matched with the second circular arc wall, and the block part is disposed on the second circular arc wall; and/or the limit part is disposed on one side of the second rotating hole away from the clamping part.

13. (canceled)

14. The neck massager of claim 11, further comprising a second positioning assembly, wherein the second positioning assembly comprises a second positioning marble and a second positioning groove formed in the block part; the second positioning groove is disposed on one side of the block part facing the second rotating hole; the second positioning marble is disposed on the main body, the second positioning groove is disposed around the second rotating axis, and the second positioning marble is matched with the second positioning groove.

15. The neck massager of claim 14, wherein the second connecting member comprises at least two second joint columns; one end of the main body comprises a positioning column; the second positioning marble is retractably disposed in the positioning column; the two second joint columns and the positioning column are respectively connected to a side wall of the second rotating hole, and a central line between the two second joint columns and the positioning column forms an acute triangle or a right triangle.

16. The neck massager of claim 11, further comprising a second limiting assembly, wherein the second limiting assembly comprises a second limit block and a stop block; the second limit block is disposed on the main body; and the stop block is disposed on the clamping arm, and is located on a rotation path of the second limit block around the second rotating axis.

17. The neck massager of claim 16, wherein the second limit block is the second connecting member, and the stop block is the block part.

18. The neck massager of claim 1, wherein each of the two clamping arms is swingable at one end of the main body towards or away from the other clamping arm.

19. The neck massager of claim 18, further comprising a swingable connection assembly, wherein the two ends of the main body are respectively connected to the two clamping arms through the swingable connection assembly, so that the two clamping arms are swingable towards or departing from each other;
the swingable connection assembly comprises a first connecting part, a second connecting part, and a swinging member; the first connecting part comprises a first installation position; the second connecting part comprises an inner side facing the first connecting part and an outer side away from the first connecting part; the second connecting part comprises a mounting hole connecting the inner side and the outer side, and the mounting hole is opposite to the first installation position; the outer side of the second connecting part comprises a third rotating member, and the third rotating member is located on one side of the mounting hole; the swinging member comprises a fourth rotating member and a second installation position, and is disposed through the mounting hole; the fourth rotating member is rotatably connected to the third rotating member, and the second installation position is connected to the first installation position; and
the first connecting part is disposed on the main body, and the second connecting part is disposed on each of the two clamping arms.

20. The neck massager of claim 19, wherein the third rotating member is two in number, and two third rotating members are respectively disposed on two sides of the mounting hole; the fourth rotating member is two in number, and the second installation position is located between the two fourth rotating members, and the two fourth rotating members are rotationally connected to the two third rotating members, respectively.

21. The neck massager of claim 20, further comprising a second rotating shaft, wherein the third rotating member comprises a third rotating hole, the fourth rotating member comprises a fourth rotating hole, and the second rotating shaft passes through the third rotating hole and the fourth rotating hole on both sides.

22. The neck massager of claim 21, wherein the second rotating shaft comprises a middle section and a telescopic section located at both ends of the middle section; a diameter of the telescopic section and the third rotating hole is smaller than a diameter of the middle section; the middle section is disposed through the fourth rotating hole, and the telescopic section is disposed through the third rotating hole.

23. The neck massager of claim 21, further comprising a torsional spring, wherein the torsional spring is disposed on the second rotating shaft; the swinging member comprises a blind hole, a first end of the torsional spring is disposed through the blind hole, and a second end of the torsional spring is pressed on an outer side of the second connecting part.

24. The neck massager of claim 23, wherein the torsional spring and the blind hole are both two in number; first ends of two torsional springs are respectively disposed through two blind holes, and second ends of the two torsional springs are connected and pressed on the outer side of the second connecting part.

25. The neck massager of claim 19, further comprising a screw fastener, wherein the first installation position is a threaded hole, the second installation position is a through hole, and the screw fastener is threaded through the through hole and connected to the threaded hole; or the first connecting part comprises a connecting groove, and the swinging member is installed in the connecting groove; the first installation position is located at a bottom of the connecting groove, and one side of the bottom of the connecting groove comprises a first wiring hole connected to the first connecting part; a second wiring hole is formed between the swinging member and a side wall of the mounting hole, and the first wiring hole communicates with the second wiring hole; or the neck massager further comprises a third connecting member; wherein the first connecting part comprises a supporting shell and a connecting shell; the supporting shell is detachably connected to the connecting shell; the connecting shell comprises a first mounting hole, the supporting shell comprises a second mounting hole, and the first mounting hole is connected to the second mounting hole through the third connecting member.

26. (canceled)

27. (canceled)
